(19) United States
(12) Patent Application Publication
(10) Pub. No.: US 2003/0179133 A1
(43) Pub. Date: Sep. 25, 2003

(54) Wireless handheld portabel navigation system and method for visually impaired pedestrians

(76) Inventors: Gilles Pepin, Drummondville (CA); Manon Gaudet, Ste-Julie (CA); Pierre Hamel, Montreal (CA)

Correspondence Address: Neifeld IP Law, P.C., Crystal Plaza 1, Suite 1001, 2001 Jefferson Davis Highway,, Arlington, VA, 22202, US

(21) Appl. No.: 10/391,604

(22) Filed: Mar. 20, 2003

Related U.S. Application Data
(60) Provisional application No. 60/365,523, filed on Mar. 20, 2002.

(51) Int. Cl. G01S 5/14

(52) U.S. Cl. 342/357.08; 342/357.1

(57) ABSTRACT

This invention relates to a system for orienting and guiding visually impaired pedestrians. The system combines a Global Positioning System (GPS) receiver to a dead reckoning unit that compensates for GPS imprecision and loss of signal. The system is highly portable: it is based on a handheld portable computing platform that communicates wirelessly with a self-powered strap containing the GPS receiver and the dead reckoning unit. The system also uses wireless protocols to receive additional orientation information from a remote location server or operator accessible through the internet.

### FIELD OF THE INVENTION

The present invention relates to a wireless handheld portable navigation system and method for visually impaired pedestrians.

### BACKGROUND OF THE INVENTION

Visually impaired persons must rely on external devices to be able to navigate and to carry about their business. Traditionally, white canes and guides dogs have, and continue to, serve their purpose.

In order to provide increased autonomy to visually impaired persons, it has been proposed to provide more automated systems, which could provide more contextual information. With the advent of the Global Positioning System of satellites, technology may take advantage of this system and attempt to provide a GPS-based navigation system. The Global Positioning System (GPS) is a navigation system that is composed of satellites turning around the earth. These satellites send signals, which are sent to the GPS receiver. It takes a minimum of three satellites in order to be able to compute a position. The more satellites available and the better they are positioned in the sky, the better is the accuracy. But in an urban canyon (tall buildings) or in streets that are very narrow, accuracy problems or even signal coverage problems will prevent the user from receiving accurate positioning information.

Two prior art systems addressing the need for a GPS based navigation system are known in the art: U.S. Pat. No. 5,470,233 (Fruchterman) and U.S. Pat. No. 6,502,032 (Newman). While the systems described in these patents disclosed adequate solutions, they both lack characteristics that would sustain a large endorsement by the visually impaired community.

The first missing characteristic is portability. To be useful to visually impaired people, a navigation system has to be highly portable. By portability, we mean a reduced weight and non bulky device. The device disclosed in the Fruchterman patent refers to a notebook computer based on an Intel 80486 CPU. At the time of that invention, a packsack was required to carry the notebook computer and the GPS receiver. Even today, with the latest developments in notebook computers, a bag or a carrying case is still needed to carry them. Newman's invention is a reduced weight device but it is still a bulky device: the system, equipped with a large Braille display and a Braille keyboard is cumbersome to wear.

The second missing characteristic in prior art systems is the universality. By this, we mean that a user should be able to power up his navigation system anywhere around the world and be able to use it. Both Fruchterman's and Newman's inventions rely on Differential GPS to improve the precision of the GPS positioning. Unfortunately, DGPS is not universal and is operated on a regional basis or local basis only. Furthermore, Newman's system uses the cellular network to access remote map servers. This implies specific infrastructure in each city where you want to operate the navigation systems.

The third missing characteristic from the previous art systems is the information return to the user in case of poor or no GPS signals available. Nothing is available to the user to either get information about his surrounding or his orientation and location which is considered a real problem. Following the user in an area where no GPS is available is therefore impossible with the previous systems. Relying on GPS signal only is not enough for a visually impaired user.

The fourth missing characteristic in previous art systems is ease of use while walking. Fruchterman's invention uses a standard 17-key, IBM-type keypad that is attached with an extension connector to the laptop computer. Newman's invention comes with a handle, a Braille keyboard and a Braille display. In both inventions, the user needs his two hands to effectively manipulate the navigation system.

### SUMMARY OF THE INVENTION

It is an object of the present invention to provide a wireless, handheld portable navigation system for visually impaired pedestrians which is portable, universal, provides information to a user even in the case where a GPS signal is poor or unavailable and is easy to use while walking.

In accordance with the invention, this object is achieved with a wireless handheld portable navigation system for visually impaired pedestrians, comprising: a GPS receiver; a dead reckoning unit; a storage system for storing information related to spatial coordinates; a digital camera for image capture; power means for powering said wireless navigation system; a handheld computing platform operatively associated with said GPS receiver, said dead reckoning unit and with said storage system for calculating a precise user position, speed and orientation on a street segment and for guiding the user on a predefined route, said handheld computing platform being further operatively connected to said digital camera; and input and output means to enter information into said system and to receive information from said system.

### BRIEF DESCRIPTION OF THE DRAWINGS

The present invention will be better understood after reading a description of a preferred embodiment thereof made in reference to the following drawings in which:

FIG. 1 is a schematic representation of the system of the present invention according to a preferred embodiment thereof;

FIG. 2 is a schematic representation of the vertical hip bounce of a user while walking;

FIG. 3 is a schematic representation of the change in direction of a user as determined by a gyroscope, using 4-bit encoding;

FIG. 4 is a schematic representation of the input commands or shortcuts used with the personal digital assistant, according to a preferred embodiment;

FIGS. 5 to 7 are schematic representations of the Braille cell according to a preferred embodiment of the invention for persons entering Braille dots using two thumbs; using their left thumb and commands using the right thumb; and using their right thumb and commands using their left thumb, respectively; and

FIG. 8 is a table describing the Braille table used by the system.

### DETAILED DESCRIPTION OF A PREFERRED EMBODIMENT OF THE INVENTION

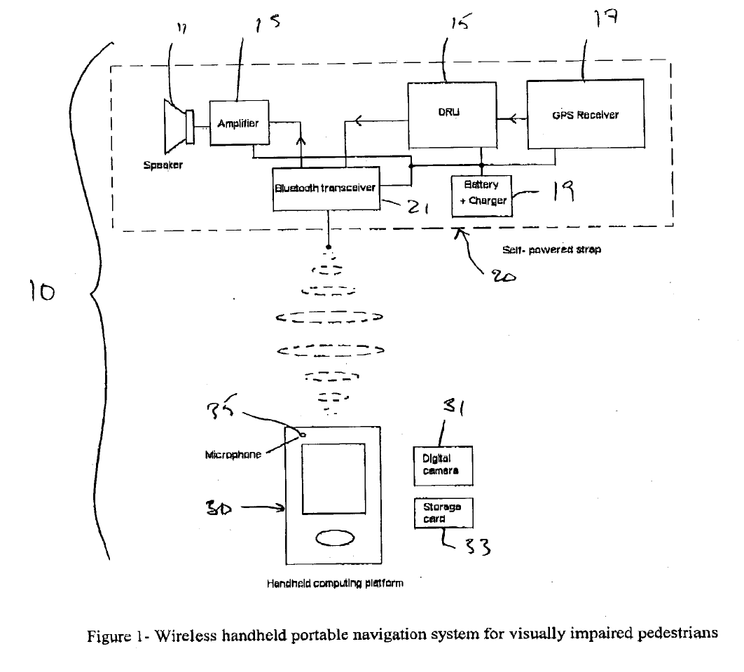

The present invention relates to a system 10 for orienting and guiding visually impaired pedestrians. The system combines a Global Positioning System (GPS) receiver 17 to a dead reckoning unit (DRU) 15 that compensates for GPS imprecision and loss of signal in order to improve the accuracy of the system 10. The system 10 also uses wireless protocols such as IEEE 802.11b, to receive additional orientation information from a remote location server or operator through the Internet. As shown in FIG. 1, the system is highly portable: it is based on a handheld portable computing platform 30, such as a Personal Digital Assistant (PDA), that communicates wirelessly with a self-powered strap 20 containing the GPS receiver 17 and the DRU 15. In a preferred embodiment of the invention, the strap is worn by the user around the neck or a shoulder, in order to provide line-of-sight positioning for the GPS receiver.

To compensate for GPS imprecision and loss of signal, the present invention relies on a built-in dead reckoning unit 15. The unit fills the gaps between the loss and reacquiring of the GPS signal. Consequently, the system can at any time interrogate the system to get information with respect to the real or estimated position.

The present invention is an orientation aid that uses the Global Positioning System (GPS) and digital maps to help visually impaired persons find their way in urban and rural areas. With this invention, users can pinpoint exactly where they are, and learn about area attractions. GPS lets users know their location, anywhere in the world, with continually growing precision.

The present invention offers visually impaired persons greater freedom, raising their confidence in their ability to travel near or far, for business or pleasure. It also helps them access and enjoy the most valuable and interesting opportunities their surroundings have to offer. The present invention contributes to guide the visually impaired through their environment. It complements existing aids (white canes and guide dogs) without, however, replacing them.

This invention advantageously provides information in the most natural way possible and allows users to record both vocal and written notes.

The system of the present invention also uses wireless protocols to receive additional information from a remote location server or operator, accessible through the internet.

With the system of the present invention, a user can interact with the system using only one hand. This is an important advantage of the system of the present invention, because visually impaired persons generally only have one had available when walking: visually impaired persons generally use a white cane or a guide dog.

Further advantageously, the system of the present invention maps a specific function to each of the five PDA control buttons. Furthermore, the present invention enables the user to use the PDA navigation button (up, down, right and left arrows), to have access to the overall menu of the software application running on the PDA, and to perform tasks such as browsing a map while walking, or use the reading mode of the system to listen to previously recorded messages.

Hardware Components

Referring now to FIG. 1, the wireless handheld portable navigation system comprises a GPS receiver 17, a dead reckoning unit 15, a storage system for storing information related to spatial coordinates 33, a digital camera for image capture 31, a handheld computing platform 30 operatively associated with the above components, input and output means for entering information into the system and to receive information from the system, and power means for powering the system.

In a preferred embodiment, as shown in FIG. 1, the output means 11, dead reckoning unit 15, GPS receiver 17 and power means 19 are disposed in a strap 20 which is adapted to be worn by a user. The handheld computing platform 30, digital camera 31, storage system 33 and input means are included in a personal digital assistant, which is in wireless communication with the strap.

More specifically, and according to a preferred embodiment of the invention, the wireless handheld navigation system comprises the following hardware components:

a self-powered bluetooth strap containing a GPS receiver 17, a dead reckoning unit 15, an amplified speaker 11, 13 and a rechargeable battery pack 19;

a Secure Data (SD) or Compact Flash (CF) card 33 for storage of the following elements: maps and associated Points Of Interest (POI), user defined POI and user defined routes;

a Digital Camera 31 for image capture;

a wireless bluetooth and 802.11b Personal Digital Assistant (PDA) 30 that calculates a precise user position, speed and orientation on a street segment and that guides the user on a predefined route.

Self-powered Strap

The self-powered strap 20 communicates wirelessly with the PDA using the bluetooth protocol through a transceiver 21. The wireless communication between the self-powered strap 20 and the PDA 30 increases the usability of the system. First, the user does not have to connect to the PDA a fragile connector that was not designed to be used by visually impaired people. Second, if the user does not have to interact with the PDA while walking and using the system, he can put the PDA aside in a coat pocket or clip it to his belt: he will still receive audio messages as he walks along the streets. Also, if the user wants to interact with the PDA while walking, he can easily manipulate the PDA using only one hand which leaves him a free hand for a white cane or a dog.

Duplex communication takes place between the PDA and the self-powered strap. The strap sends to the PDA two types of information: positioning information coming out from the GPS receiver, and distance traveled/change in direction by the user coming out from the dead reckoning unit. The PDA sends to the self-powered strap ON/OFF signals and audio signals to be played by the strap speaker.

Dead Reckoning Unit

A dead reckoning unit (DRU) 15 is part of the system and was designed to compensate for GPS imprecision and loss of signal. The DRU comprises three main components: an accelerometer, a gyroscope and a micro controller.

The DRU provides to the system the distance walked by the user and the change in direction by the user. Using these two measures combined to a digital map, the system is able to follow the user path on street segments even if a loss of GPS signal occurs.

Measure of the Distance Walked by the User

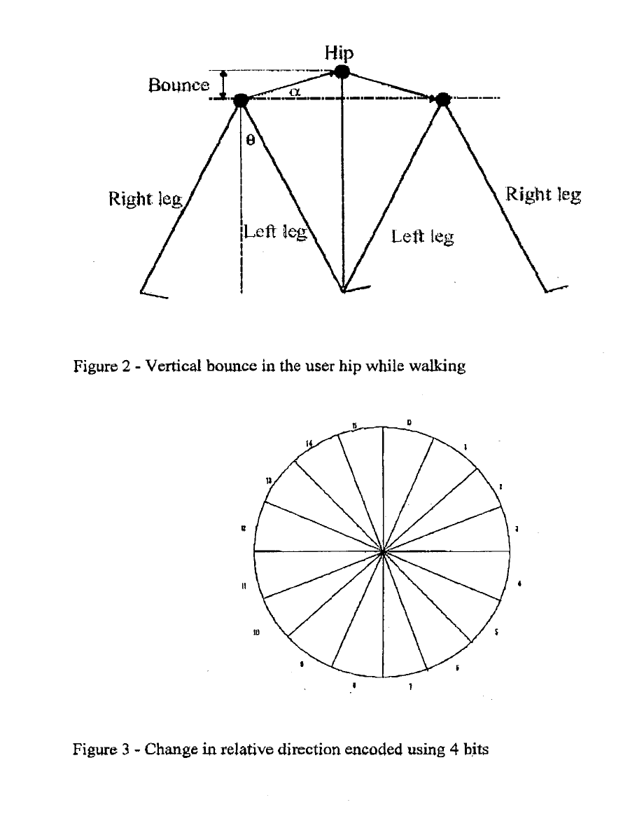

As shown in FIG. 2, a vertical bounce occurs in the user hip at each step the user does while walking. The measure of the distance traveled by the user is estimated from these vertical bounces.

The DRU sends to the system two parameters:

Walking state (WALKING or NOT_WALKING) (1 bit)

Number of steps (typically transmitted at each second) (4 bits)

The walking state is determined using one accelerometer that detects the vertical bounces that occur at the hip while the user is walking. A pass band filter is used to filter vertical bounces from interference bounces generated by arm movements or rotational movements.

If the user is walking, the system calculates the distance traveled by the user between two points by multiplying the number of steps by the average distance of a user step (the average distance of a step is calculated by dividing the distance between 2 precise GPS positions by the number of steps occurred between these 2 positions).

Measure of the Change in Direction by the User

Relative direction of the user is determined from a gyroscope. The gyroscope was chosen because of its precision and because it is not affected by the presence of metallic masses or magnetic fields. However, the present invention is not limited to using a gyroscope or even an accelerometer. Other components which can provide an estimation of the distance traveled by a user and a change in the direction of travel in order to form a dead reckoning unit falls within the scope of the present invention.

The output of a gyroscope is an instantaneous angular velocity (number of degrees per second). The number of degrees covered is obtained by integrating the instantaneous angular velocity over one second. For example, if the user turns 90 degrees clockwise in one second, the DRU will transmit the value 90 degrees to the system.

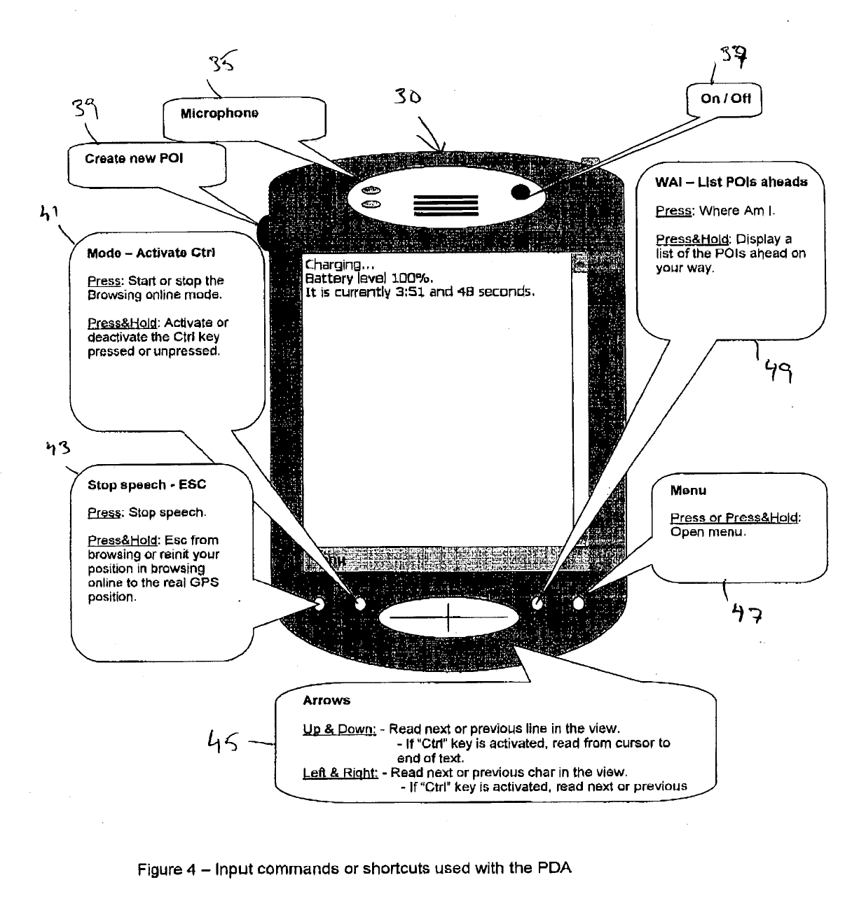

As shown in FIG. 3, change in relative direction is encoded using 4 bits for a resolution of 22.5 degrees.

Accessible Handheld Computing Platform

PDA's Button Interface

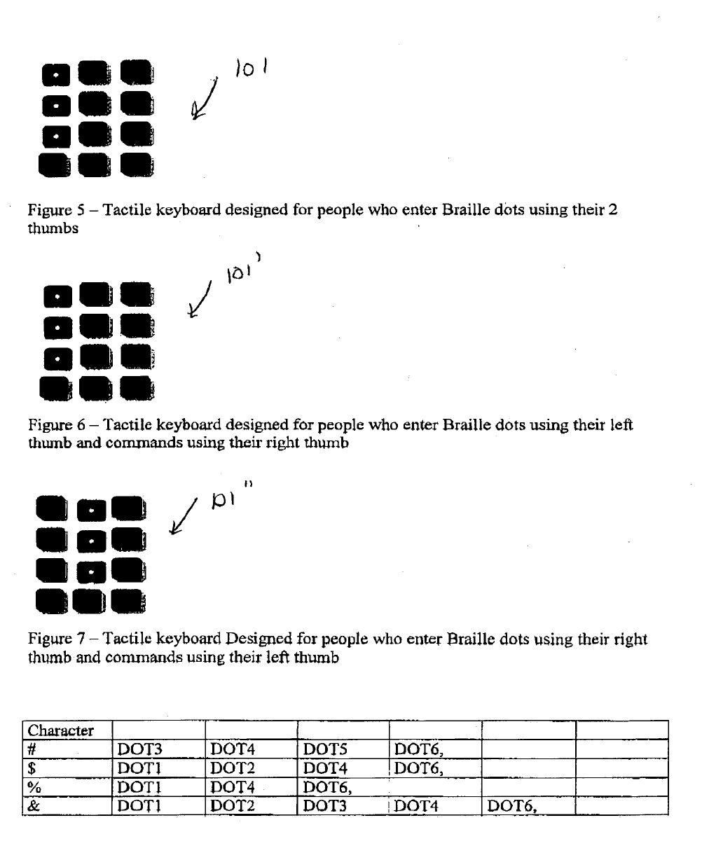

Parts of the PDA had to be adapted for the blind or those with low vision in order to let them easily interact with the system of the present invention. As shown in FIG. 4, the buttons 39, 41, 43, 45, 47, 49, 37 of the front panel and the side panel of the PDA were adapted to be used as input commands or shortcuts to the system. Four buttons 41, 43, 49, 37 and a navigation button 45 are available on the front panel. The ‘Where Am I’ function is mapped to one of the four buttons, as well as the stop speech, the Reading/Browsing mode and the menu access. The side panel button 39 is used as a shortcut to create a point of interest via a voice recording. By pressing the button, the user records a significant message related to the point of interest that he wishes to create, like the name of the point of interest, or other meaningful information. The navigation button is used to navigate the menu or to virtually browse the map.

Voice Command Input

Using the PDA's microphone and an off-the-shelf speech recognition engine, users can also interact with the system using the voice command. The system takes as input the voice of the user and if a pattern is recognized, the associated command is performed.

Touch Screen Input

The touch screen of the PDA is also used as another way to exchange information with the system. Touching the screen at specific places may input text to the system or invoke specific commands. However, it has been discovered that a tactile keyboard is an important advantage of the present invention in order to enable a user to enter information, as will be seen hereinafter.

Tactile Keyboard

A tactile keyboard representation is preferably used when inputting text to the system. A Braille cell 101, 101′, 102″, or telephone keyboard representation over the touch screen, is the tactile implementation that is preferred in the context of the present invention. The touch screen of the PDA is pressed at a specific location, to reproduce input of the corresponding character via, either the combination required by the Braille alphabet, or a telephone keyboard press.

Touch Screen Braille Cell

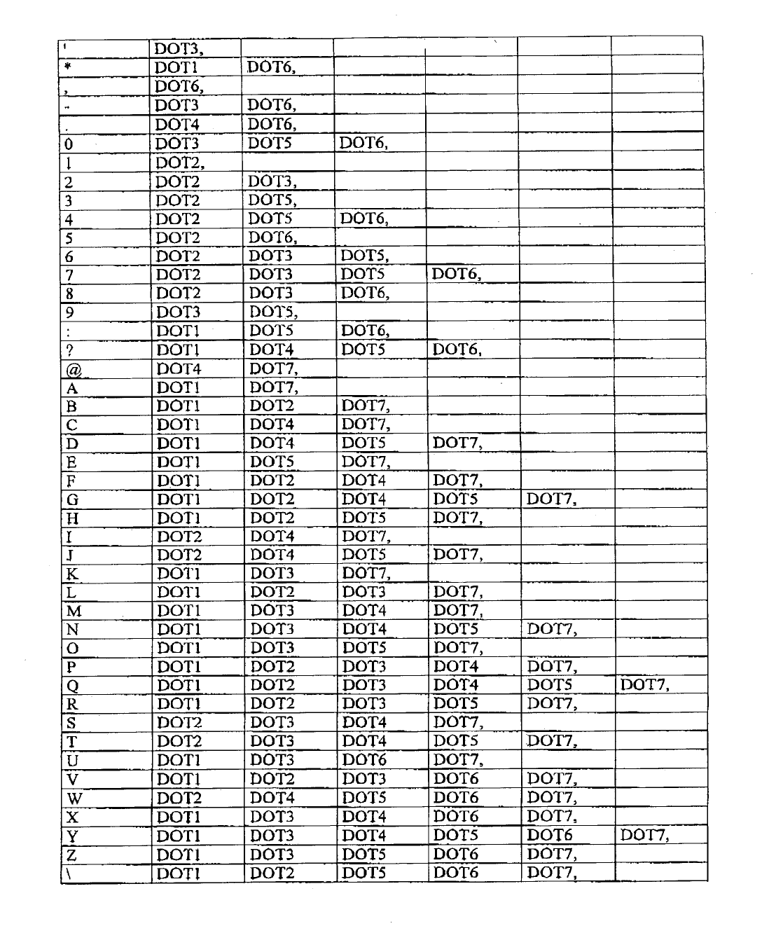

As shown in FIG. 5, the screen is divided like a Braille cell, which makes it easy for a Braille user to enter text. The screen is divided into twelve equal squares, four rows and three columns, representing 12 dots. The side columns represent a Braille cell (matrix of 2×4 dots).

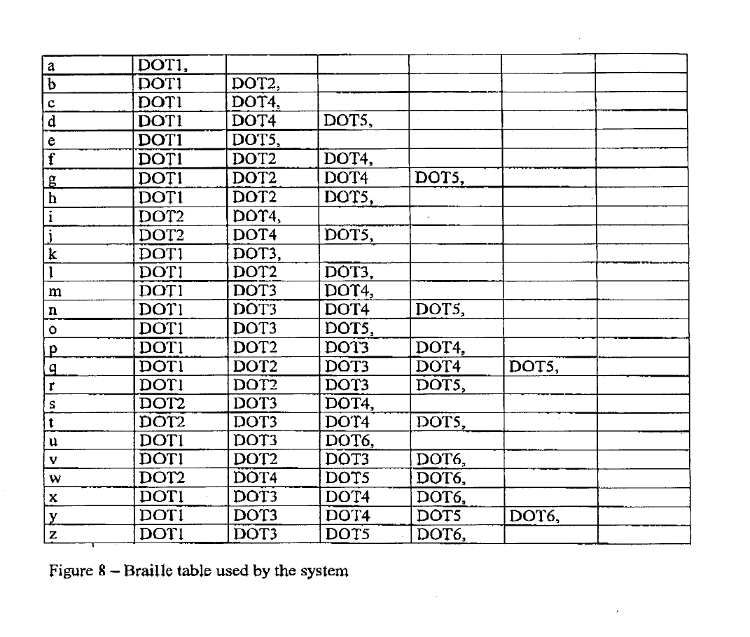

The Braille table used by the system is described in FIG. 8. The first column of the screen is numbered row 1: DOT 1, row 2: DOT 2, row 3: DOT 3, row 4: DOT 7. The third column is numbered row 1: DOT 4, row 2: DOT 5, row 3: DOT 6, row 4: DOT 8. For example, to enter the letter ‘A’, the user needs to press DOT 1 and DOT 7. When a dot is pressed, it stays down until the character is either accepted or cancelled. This enables a user to press each dot separately with only one or two fingers.

The middle column of the screen is used as a command column. The first dot of the middle column, at the top, is the Accept command. This is used to accept that the entered character is appended to the current string. The second dot of the middle column is the Space command. This is used to append a space to the current string. The third dot of the middle column is the Backspace command. It cancels the current configuration of the cell, if there is one, or deletes the previous character if no configuration is pending. The fourth and last item of the middle column has no function for the moment.

To enter a character, the user taps on the screen in the appropriate spaces, and the corresponding character is heard. The user than accepts the character to append it to the current string, or cancels the operation and redo the tapping. The Braille Cell interface requires a certain degree of training in order to learn to place the thumbs to the right place. It is suggested to take the PDA in both hands, and reach for the screen with both thumbs for faster input.

The disposition of the braille dots/command dots can be set by the user. There are 3 available configurations:

1. Designed for people who enter Braille Dots using their 2 thumbs (see FIG. 5)

2. Designed for people who enter Braille Dots using their left thumb and commands using their right thumb (see FIG. 6)

3. Designed for people who enter Braille Dots using their right thumb and commands using their left thumb (see FIG. 7)

The Braille Cell can also be configured with 6 or 8 dots (instead of 12). When set in 6 or 8 dots mode, this Braille cell is used only to type in Braille characters. A user presses the dots on the screen to form a Braille Character and presses a button on the PDA when the character configuration is completed.

Touch Telephone Keypad

The screen is divided like a telephone keyboard, which makes it easy for people, who are not Braille users, to enter text. The screen is divided into twelve equal squares—four rows and three columns. The following representation of the telephone keyboard is used:

| | | |
|---|---|---|
| 1 | 2, A, B, C | 3, D, E, F |
| 4,G,H,I | 5, J, K, L | 6, M, N, O |
| 7, P, Q, | 8, S, T, U | 9, V, W, X |
| R | | |
| * | 0, Y, Z | # |

Ten digits plus the NUMBER sign and the STAR are represented. To each digit of this Touch Telephone Keypad are associated several letters. The user presses on a digit until the desired letter is found (heard). When the letter is found, the user presses a button of the PDA to add it in the text string.

Plastic Molded Membrane for the Input Adapted Keyboard

A thin plastic membrane molded as a Braille cell, or telephone keyboard, as described in the previous section, is in twelve sections equally divided. This membrane is put over the touch screen of the PDA, to serve as delimiter for the input adapted keyboard.

Speaker Output

The system gives audio information to the user via the PDA's speaker but also via the speaker 11 located on the strap. When the user is in an urban environment, cars and other vehicle make a lot of noise. The PDA's speaker is not enough for the user to hear clearly what the system is telling him, therefore, the use of a speaker is required.

User Interface

The following section details the advancements to the previous art system described in U.S. Pat. No. 5,470,233 issued to Fruchterman et al., and their related advantages.

It is imperative that the user knows in which type of GPS reception he is, in order to better estimate his chances of accurately orienting himself, at any moment. Therefore, we have conceived a specific GPS interface which is comprised of:

a. Verbal information to the user, upon request, on the quality of the GPS signal reception. The following reception status are given to the user: No Coverage, Poor Coverage, Good Coverage.

b. A tone, upon passing from a poor or good GPS reception to No Coverage is heard automatically, when the GPS signal has been lost for some time. This way, the user is informed that at the given time, a certain functionality of the system is not working.

c. Upon user's request, it is possible for him to know, at any moment, what type of accuracy he can expect of the system. An estimation, in feet or meters, of the radius of precision regarding his position is given. The user may then make better estimation of his orientation at that specific moment.

d. The user have access to physical system information regarding the battery level given as a percentage, the map information such as the name of the loaded map, its version, the storage left on the device, which is the SD or CF card, help the user to make decisions regarding the creation of points of interests, or cleaning he has to make in order to add space for further input to the system.

e. Searching information in the points of interest database, with search filters such as POI category, POI name or address is very useful to the user, in order to easily find a telephone, or change a specific information about this POI.

f. Activation or deactivation of a POI is available to the user so that specific POIs can no longer be detected or can be detected again when the user is crossing their location. Unlike the deletion of a POI, all the information is kept, but no longer referred to, except when you activate it again.

g. Favorite attribute can be associated to a POI, in order to improve search performances or select browsing origin easier.

h. When the user, for any reason, did not hear the information given by the system, it is possible for him to get this information back. A Reading Mode is provided to the user, in order to listen to previous messages. The user only has to touch the up arrow, and the system will go through, line by line, all the previous messages available.

i. When the user is in an area that covers many points of interest, a commercial center for example, it would be very inconvenient for the user to hear all of the boutiques information comprised in this zone. We have decided to put them available to the user via a list in a dialog box, after detecting some three different POIs in a small area.

j. Creation of a POI, while outside can be very demanding if you have to enter text in the middle of a street. Using the recording of voice, and creating at the same time a POI, with a default name, is somewhat easier. The user presses a button, and talk to the microphone, giving a strategic information in order to recognize it later.

k. Creating a POI while virtually browsing the map is important so that the user does not necessarily have to go outside in order to create a POI. The user enters the browsing mode, goes to the desired position and creates a POI with the same recording/poi creation button.

l. Creating a route while virtually browsing the map is as well important so that the user does not necessarily have to go outside in order to create a route. The user may create a bread crumb route, or enter specific address as origin and destination, or a POI as origin or destination, and the system computes a route for the user. If address is given, estimate position (latitude and longitude) of the address is computed.

m. When the user is executing a route, meaning he is being guided through a route, it is possible for him to hit the reverse button of the PDA, which automatically reverse the route from the current position, and guides the user back to his origin.

n. Tunnel detection mode: detection of points of interest, while the user moves, can be done in a tunnel mode, detecting only the POIs that are located in a virtual tunnel, according to the user's heading.

o. Different voices to create stereo effect: detection of a point of interest takes into account its relative position to the user, if the POI is located at the user's left, the user will hear a certain voice attributed to the left side, another voice is used when detection occurs at the right side.

Wireless Communication with the Internet

The present invention uses wireless protocols, such as IEEE 802.11b, to connect to the internet and to download up to date information. IEEE 802.11b protocol, commonly known as WI-FI, is gaining popularity in the office and at home. Moreover, multiple WI-FI public-access networks are under development in the United States, in the U.K. and in other countries.

The present invention integrates the WI-FI protocols and enables the user to easily download up to date map data from a remote map server.

The present invention also enables the user, while walking, if WI-FI public “hot spots” are available, to download up to date information on specific Points of Interest (POI) that he is crossing (restaurant menu, opening hours of a bank, etc.).

The information downloaded from the internet can add valuable hints to the user about his surrounding and/or information about buildings and their functions, for example: how to get to the metro station from where he stands, how to go by in the station, or any other information that adds to the orientation of the user. The user may use this information for further reference. Tourist information can also be downloaded as well as predefined routes for the user. Any useful information to the user can be downloaded from the internet.

Image Analysis

The present navigation system supports image analysis that is used by visually impaired pedestrians to increase their orientation and surrounding knowledge.

Image analysis is used for tasks such as: locate the entrance of a building and guide the user to that entrance; identify objects or signs encountered by the user while walking; provide the user with indoor guiding instructions; provide the user with outdoor guiding instructions if the GPS signal is not available.

The visually impaired pedestrians use the system digital camera to grab still images that are automatically transferred, through WI-FI internet, to a remote image server or operator. Still images are transferred to the remote image server/operator using the file transfer protocol (ftp).

The still images are analyzed by the remote image server/operator. Results of image analysis are produced in text format and sent back to the navigation system. The system then converts the textual information into speech.

Although the present invention has been explained hereinabove by way of a preferred embodiment thereof, it should be pointed out that any modifications to this preferred embodiment within the scope of the appended claims is not deemed to alter or change the nature and scope of the present invention.

We claim:

1. A wireless handheld portable navigation system for visually impaired pedestrians, comprising:
a GPS receiver;
a dead reckoning unit;
a storage system for storing information related to spatial coordinates;
a digital camera for image capture;
power means for powering said wireless navigation system;
a handheld computing platform operatively associated with said GPS receiver, said dead reckoning unit and with said storage system for calculating a precise user position, speed and orientation on a street segment and for guiding the user on a predefined route, said handheld computing platform being further operatively connected to said digital camera; and
input and output means to enter information into said system and to receive information from said system.

2. A wireless navigation system according to claim 1, wherein said storage system is a secure data or compact flash card.

3. A wireless navigation system according to claim 2, wherein said information related to spatial coordinates includes maps, points of interest, user defined points of interest and user defined routes.

4. A wireless navigation system according to claim 1, wherein said GPS receiver, said dead reckoning unit and said output means are in wireless communication with said handheld computing platform.

5. A wireless navigation system according to claim 4, wherein said wireless communication is effected through bluetooth technology.

6. A wireless navigation system according to claim 1, wherein said dead reckoning unit comprises: an accelerometer that is used to measure a distance traveled by the pedestrian and a gyroscope that is used to measure a change in direction by the pedestrian.

7. A wireless navigation system according to claim 1, wherein said output means include audible output means for providing audible cues to said pedestrian.

8. A wireless navigation system according to claim 7, wherein said audible cues include:
a. vocal GPS information regarding the quality of signal reception;
b. a tone associated with GPS status;
c. vocal GPS information regarding the estimated position accuracy that can be expected by the system, at the time of a user inquiry; and
d. vocal system information regarding system resources.

9. A wireless navigation system according to claim 1, wherein said handheld computing platform is a personal digital assistant.

10. A wireless navigation system according to claim 9, wherein buttons of front and side panels of said personal digital assistant are used as short keys to input commands.

11. A wireless navigation system according to claim 1, wherein a voice command is one of the input means.

12. A wireless navigation system according to claim 7 wherein a touch screen panel of said personal digital assistant is used as input means.

13. A wireless navigation system according to claim 12 wherein said system further includes a tactile keyboard.

14. A wireless navigation system according to claim 13 wherein a plastic membrane moulded as a Braille cell or a telephone keyboard is placed over the touch screen as delimiter for the tactile keyboard;

15. A wireless navigation system according to claim 1 wherein said wireless handheld computing platform uses wireless protocols to connect to the internet and to download up to date information.

16. A wireless navigation system according to claim 1 wherein said wireless handheld computing platform uses wireless protocols to transfer images captured by the digital camera to a remote location server or operator.

17. A wireless navigation system according to claim 16 wherein a remote location server or operator capable of image analysis is adapted to receive transmissions from the system and identify objects within an image for the user.

18. A wireless navigation system according to claim 17 wherein said wireless handheld computing platform uses wireless protocols to receive, from said remote location server or operator, image analysis results such as entrance location of a building and guiding instructions to that entrance; identification of objects or signs encountered by the user while walking; indoor guiding instructions and outdoor guiding instructions if the GPS signal is not available.
